(19) United States
(12) Patent Application Publication
(10) Pub. No.: US 2021/0328204 A1
(43) Pub. Date: Oct. 21, 2021

(54) BATTERIES AND METHODS OF USING AND MAKING THE SAME

(71) Applicant: EaglePicher Technologies, LLC, St. Louis, MO (US)

(72) Inventors: Dong Zhang, Webb City, MO (US); Jason A. Mudge, Joplin, MO (US); David Timothy Andrew Darch, Neosho, MO (US); Mario Destephen, Joplin, MO (US); Ernest Ndzebet, Carl Junction, MO (US); Umamaheswari Janakiraman, Webb City, MO (US)

(73) Assignee: EaglePicher Technologies, LLC, St. Louis, MO (US)

(21) Appl. No.: 16/851,010

(22) Filed: Apr. 16, 2020

(51) Int. Cl. H01M 2/26; H01M 4/66; H01M 4/80

(52) U.S. Cl. CPC H01M 2/26; H01M 4/80; H01M 4/661

(57) ABSTRACT

Batteries and methods of using and making batteries are provided. A cell can include a housing; a cathode current collector, in the housing, including a cathode tab and a cathode plate. The cathode tab can include a tab area. The cathode plate can include a plate area and a peripheral edge that surrounds at least a portion of the plate area. The peripheral edge can include a plurality of partial perforations. The plate area can include a plurality of interior perforations. The cell can further include an anode current collector, in the housing, including an anode tab; an anode, in the housing, provided adjacent the anode current collector; and a cathode, in the housing, provided adjacent to the cathode current collector.

### BACKGROUND

The disclosed subject matter relates to batteries, and methods of use and manufacture thereof. More particularly, the disclosed subject matter relates to a battery with one or more cells provided with a cathode current collector and an anode current collector.

The technical field of the disclosure is batteries including, for example, primary lithium batteries. The term “primary” can denote a non-rechargeable electrochemical cell, in contrast to the term “secondary” which can denote a rechargeable electrochemical cell. A battery can include one or more cells.

Primary lithium batteries can include those having one or more lithium anodes, paired with cathodes. During the discharge of such a battery, oxidation of the lithium metal to lithium ions can take place at the anode. At the cathode, the reduction of the oxidizing substance can take place. During discharge, the oxidation of the lithium metal to lithium ions can occur at the anode, and the lithium ions can leave the anode surface and migrate into the porous cathode.

However, there are various problems associated with the above described and other known technology.

### SUMMARY

Batteries and methods of using and making batteries are provided. A cell can include a housing; a cathode current collector, in the housing, including a cathode tab and a cathode plate. The cathode tab can include a tab area. The cathode plate can include a plate area and a peripheral edge that surrounds at least a portion of the plate area. The peripheral edge can include a plurality of partial perforations. The plate area can include a plurality of interior perforations. The cell can further include an anode current collector, in the housing, including an anode tab; an anode, in the housing, provided adjacent to the anode current collector; and a cathode, in the housing, provided adjacent to the cathode current collector.

Various further aspects and features of the disclosure are described below.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 illustrates a perspective view of an electrochemical cell with detail of a cathode current collector, in accordance with one or more embodiments of the present disclosure.

FIG. 2 illustrates an exploded view of an electrochemical cell the same as or similar to the cell of FIG. 1, in accordance with one or more embodiments of the present disclosure.

FIG. 3 is a cross-section view, along line 3-3 of FIG. 1, of an electrochemical cell the same as or similar to the cell of FIG. 1, in accordance with one or more embodiments.

FIG. 4 is a perspective view of the anode current collector to which can be attached two lithium coupons (or anodes), in accordance with one or more embodiments.

FIG. 5 is an example of an anode current collector (in a flat form), in accordance with one or more embodiments.

FIG. 6 is a perspective view of the anode current collector and two lithium coupons (i.e. anodes), in accordance with one or more embodiments.

FIG. 7 is a perspective view of a header assembly of a battery showing details of the cell of FIG. 2, in accordance with one or more embodiments.

FIG. 8 is a cross-section view, along line 8-8 of FIG. 7, of a header assembly the same as or similar to the header assembly of FIG. 1, in accordance with one or more embodiments.

FIG. 9 is a top view of a header assembly in accordance with one or more embodiments.

FIG. 10 is a bottom perspective view of a header assembly of FIG. 1, in accordance with one or more embodiments of the disclosure.

FIG. 11 is a top perspective view of a header assembly of FIG. 1, in accordance with one or more embodiments of the disclosure.

FIG. 12 is a perspective view of a cathode current collector of an electrochemical cell, in accordance with one or more embodiments of the present disclosure.

FIG. 13 is a top view of a cathode current collector of an electrochemical cell, the same as or similar to the cathode current collector of FIG. 12, in accordance with one or more embodiments of the present disclosure.

FIG. 14 is a table showing aspects of pulse voltage of electrochemical cells of the disclosure, in accordance with one or more embodiments of the disclosure.

Unless otherwise indicated illustrations in the figures are not necessarily drawn to scale.

### DETAILED DESCRIPTION OF THE DISCLOSURE

The present disclosure relates generally to the field of electrochemical cells. In particular, the present disclosure relates to a new cathode arrangement that includes a perforated current collector. The cathode arrangement of the present disclosure can be useful for an electrochemical cell that has improved high energy density that can power implantable medical devices. In at least one of the embodiments, the present disclosure relates to lithium/fluorinated carbon (Li/CFₓ) electrochemical cells for use in implantable medical devices.

Li/CFₓ electrochemical cells are known to be used in medical devices including implantable medical devices. The environment in which cells of this type can be used can require high energy density and high cell discharge efficiency, with minimized battery size to power medical devices. In this regard of the present disclosure, the current collector in the cathode can be optimized to improve the energy density and cell discharge efficiency. An optimized cathode collector for a primary lithium electrochemical cell is therefore sought, having improved discharge efficiency over those of the prior art. The improved discharge efficiency can result in an increase in the discharge voltage and the discharge capacity, and thus the energy density, of the electrochemical cell.

As known by those having ordinary skill in the art, a battery can include an anode, a cathode, a separator, an electrolyte, and two current collectors (each in cathode and anode). For a primary battery, a current collector can be an electronic conductor that collects current passing through the cathode and anode during discharge. The electrical current then flows from the cathode current collector through a device being powered to the anode current collector.

In the art there are references to the arrangement of current collector of lithium cells. In US Patent Application 2017/0104207 entitled Sandwich Cathode Lithium Battery with High Energy Density, the disclosure describes that a perforated substrate can serve as the cathode current collector. The substrate can be a metal selected from the group consisting of stainless steel, titanium, tantalum, platinum, gold, aluminum, cobalt nickel alloys, nickel-containing alloys, highly alloyed ferritic stainless steel containing molybdenum and chromium, and nickel-containing alloys, chromium-containing alloys and molybdenum-containing alloys, for example. The substrate material for the cathode current collector can be aluminum, for example. In an embodiment, the perforated substrate may be constructed from or in a continuous sheet form, such as a reel or roll.

It is also mentioned in US Patent Application 2017/0104207, that shapes of perforations include, but are not limited to, a circle, an oval, a rectangle, a star, or a triangle. Also, percent of open area of cathode current collector can be 20 to 30 percent. The thickness of the cathode current collector can be from about 0.07 mm (millimeters) to about 0.03 mm.

U.S. Pat. No. 9,077,030 describes that current collectors used in the electrodes of IMD batteries are of the type used conventionally. Generally, they are metal films or foils, such as aluminum, titanium, nickel, copper, or another conductive metal that is corrosion-resistant when associated with the active anode material. They may be primed or unprimed. They may be perforated or not. The thicknesses of the current collectors can be at least 0.0001 inch, and can be at least 0.003 inch. The thicknesses of the current collectors are typically no greater than 0.01 inch (e.g., a titanium current collector is typically 0.005 inch thick to handle the current load without becoming excessively hot), and often no greater than 0.001 inch (e.g., an aluminum current collector can be as thin as 20 microns (0.0008 inch)).

JP2007173245 describes that a preferable conductive material is acetylene black mixed with a polytetrafluoroethylene (PTFE) binder and dried in a powder-like form. A collector base material is a foil of nickel or stainless steel of a mesh or another fine porous shape. By adjusting the center position of the collector base material, the filling amount of a conductive mixture onto the front and back surfaces of the base material is controlled. Thereafter, the dried powder-like conductive mixture is continuously supplied to a calendar hopper, and fixed in perforated pores of the collector base material before being cut into appropriate sizes, whereby a conductive structure is formed.

JP 2017152243 describes that the fuel cell includes at least one or more positive electrodes and one or more negative electrodes, wherein the positive electrode comprises a plate-shaped positive electrode current collector and a positive electrode active material layer, and the negative electrode has a plate-like negative electrode current collector and a negative electrode active material layer provided on both sides or one side of the negative electrode current collector, and the positive electrode current collector and the negative electrode current collector is composed of a perforated plate having a plurality of through holes and the positive electrode current collector and the negative electrode current collector each have a plurality of through holes. The opening ratio K1 of the positive electrode current collector is lower than the opening ratio K2 of the negative electrode current collector, when the ratio of the total area of the negative electrode current collector to the total area ratio is the opening ratio K (K1, K2).

In view of the foregoing, it is clear that these traditional techniques possess deficiencies and leave room for improved approaches. Particularly, in the field of implantable medical devices, a smaller battery size may be desired and hence it may be desirable to optimize the arrangement of cathode current collector for lithium electrochemical cells, to achieve high energy density.

The present disclosure provides a lithium electrochemical cell with increased energy density. The electrochemical cell of the disclosure provides an improved cathode arrangement with a cathode active material disposed on both faces of a current collector. The current collector can be perforated to increase the adhesion of cathode active material to the cathode current collector and to maintain the integrity and continuity of the cathode. The current collector may be coated with a conductive carbon layer to improve the electrical conduction continuity from cathode active material to the cathode current collector. The described cathode arrangement can be useful for a high-energy-density electrochemical cell to power implantable medical devices.

In one or more embodiments, the present disclosure can provide an electrochemical cell that converts chemical energy to electrical energy. Particularly, at least one embodiment provides an electrochemical cell having a cathode with an active material of fluorinated carbon on a perforated metal cathode current collector, a lithium anode on a perforated metal anode current collector, a stable electrolyte, and a separator. In various embodiments, the disclosure provides an anode current collector arrangement, a cathode current collector arrangement, a cathode formulation, an electrolyte formulation, a separator, and a battery incorporating the electrochemical cell.

In one or more embodiments, the present disclosure provides an electrochemical cell having a cathode with an active material of fluorinated carbon on a perforated metal cathode current collector.

In one or more embodiments, the present disclosure describes an electrochemical cell having an improved cathode arrangement that includes a cathode current collector coated with conductive carbon to improve the electrical conduction continuity from cathode active material to the cathode current collector.

The present disclosure is best understood by reference to the detailed figures and description set forth herein.

Embodiments of the disclosure include a primary lithium-based electrochemical cell. It may be appreciated that those skilled in the art can, in light of the teachings of the present disclosure, understand that the term “primary” can denote a non-rechargeable electrochemical cell, in contrast to the term “secondary” which can denote a rechargeable electrochemical cell. As used herein, a battery, can include one or more primary electrochemical cells. Typically, primary lithium batteries are those having metallic lithium anode, pairing with various cathodes, including Li/CFₓ, Li/MnO₂, Li/SVO, and Li/Hybrid, where Hybrid is a mixture of CFₓ, and/or MnO₂, and/or SVO.

During the discharge of such a battery, the oxidation of the lithium metal to lithium ions can take place at the anode according to the following reaction:

Li→Li⁺+e

The reduction of the oxidizing substance can occur at the cathode. In the case where the oxidizing agent is CFₓ, the reduction reaction can be as follows:

CFₓ+e+xLi⁺→C+xLiF

During discharge, the oxidation of the lithium metal to lithium ions can occur at the anode, and the lithium ions leave anode surface and migrate into the porous cathode. At the cathode during discharge, the insertion of lithium into CFₓ can take place, producing insoluble lithium fluoride and graphite (an electronic conductor).

In one or more embodiments, carbon monofluoride (CFₓ) can be used as the cathode active material for the present disclosures. The overall discharge reaction in a Li/CFₓ cell is shown in the following equation 1.

xLi+CFₓ→C+xLiF (Equation 1)

Embodiments of the disclosure are described below with reference to the figures. Those skilled in the art will readily appreciate that the detailed description given herein with respect to these figures is for explanatory purposes as the disclosure extends beyond these limited embodiments.

In one or more embodiments an electrochemical cell is provided. The electrochemical cell can include a cathode, an anode, a separator, and an electrolyte. The cathode can include a cathode formulation. The cathode formulation can include a cathode active material, a conductive carbon filler, and a binder. The cathode formulation can be disposed on a cathode current collector. The anode can include at least two lithium metal foils disposed on an anode current collector. The electrolyte can include a lithium salt in a mixed solvent. The ratio of an amount of electrolyte to an amount of cathode active material can be about 0.7 to about 1.1.

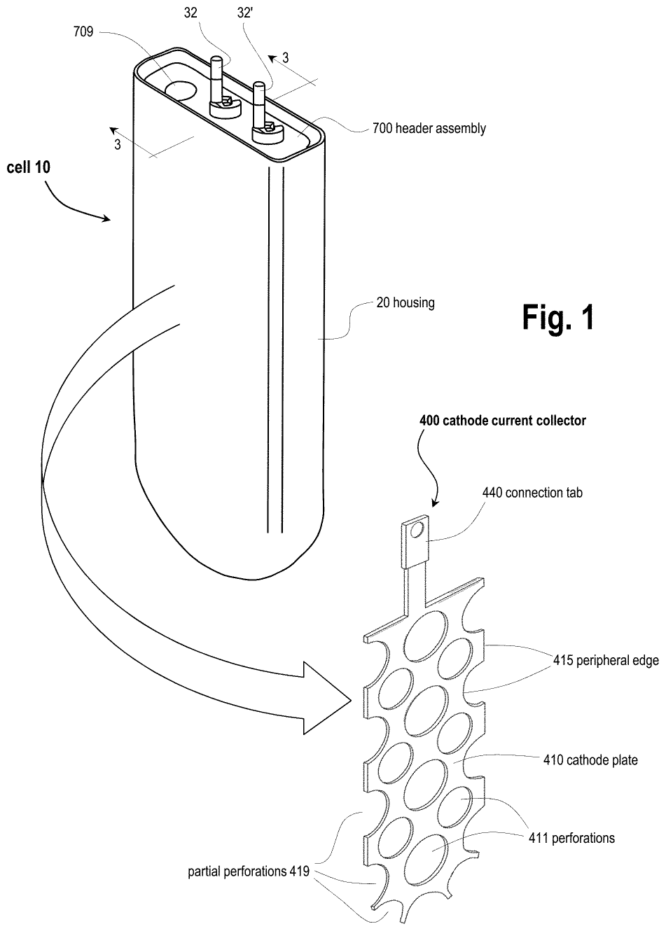

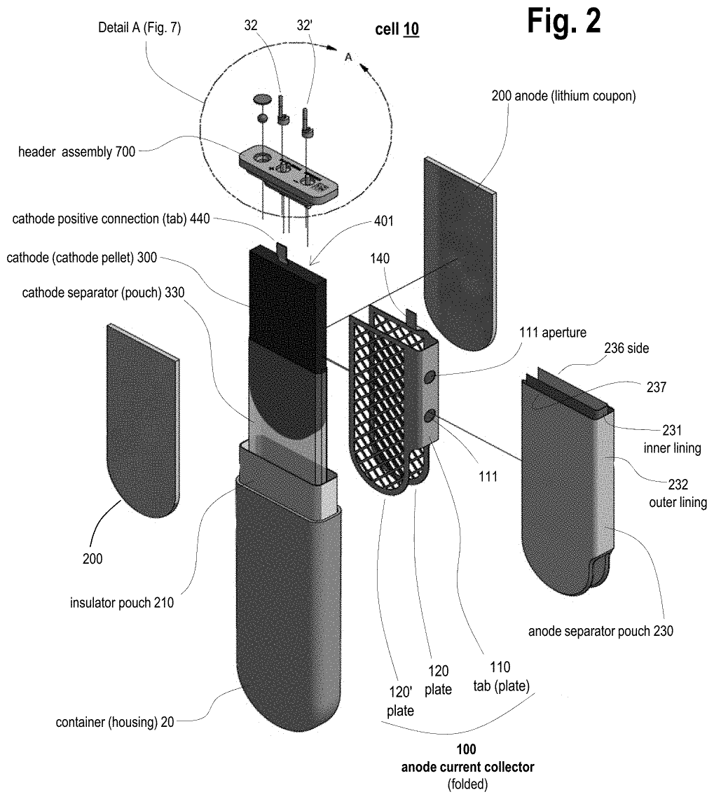

Referring to FIG. 1, a perspective view of an electrochemical cell 10 is provided in accordance with at least one embodiment of the present disclosure. The electrochemical cell includes an outer casing or housing 20, and a header assembly 700. The header assembly 700 includes a vent location 709, and pins 32 and 32′ for external connection. Internally, of an electrochemical cell 10, the pin 32 can be connected (via a tab 440) to a cathode current collector 400 as shown in FIG. 2, and the pin 32′ can be connected (via a tab 140) to the anode current collector 100, as shown in FIG. 2. The tab 440 can be characterized as a cathode tab 440 or alignment tab 440. The tab 140 can be characterized as an anode tab 140. The disclosure is not limited to such particular connection arrangement and other arrangements may be utilized.

In one or more embodiments, the cathode of the cell 10 includes the cathode current collector 400. It may be appreciated to those skilled in the art will, in light of the teachings of the present disclosure, that the cathode current collector 400 may include and/or can be constructed of any suitable material known to be used in the art as a cathode current collector material. Suitable materials may include, but are not limited to, stainless steel, aluminum, and titanium. In an exemplary embodiment, the material used for the cathode current collector is stainless steel, such as, for example, SS316, SS316L, SS304.

In one or more embodiments, the cathode current collector 400 is perforated with perforations 411, i.e. interior perforations 411. In an exemplary embodiment, the perforations 411 can include large circles or perforations 413 and small circles or perforations 412 in order to maximize the void area, i.e. an area taken up by the interior perforations 411, while maintaining the cathode current collector strength and integrity. The maximized void area can be beneficial for enhancing the adhesion between the two halves 300, 300 of the cathode pellet (see FIG. 2) sandwiching the current collector 400. The ratio of number of large circles 413 to small circles 412 can be about 4:3, in accordance with one or more embodiments of the disclosure. The void area or areas can take various shapes including circular, square, diamond, rectangular, and triangle, for example.

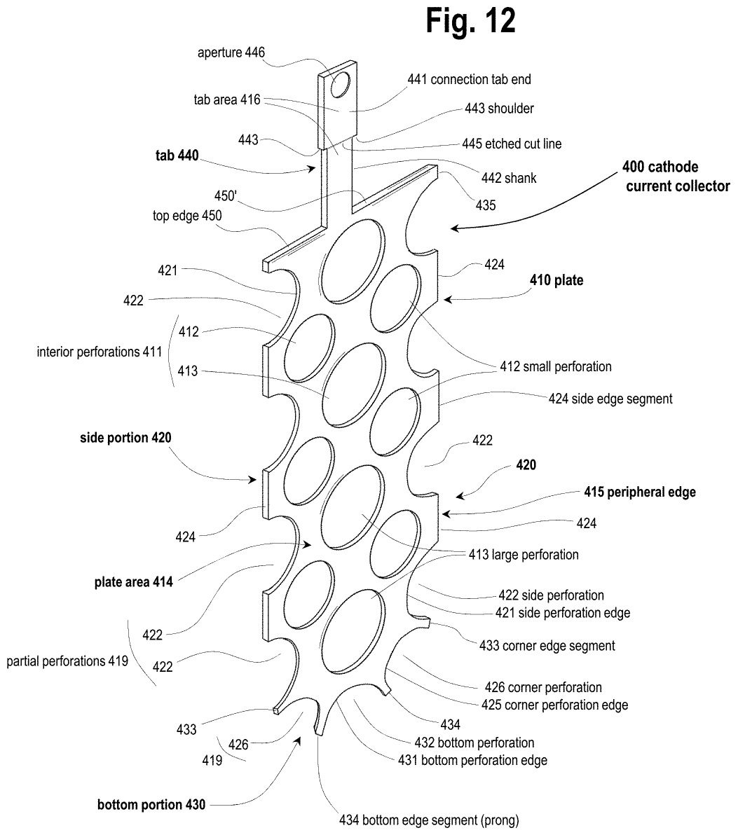

In one or more embodiments, the diameter for the large circles 413 in FIG. 12 may be in a range of about 3.0 millimeter (mm) to about 2.0 mm. In another embodiment, the diameter for the large circles 413 may be in a range of about 2.8 mm to about 2.2 mm. In yet another embodiment, the average diameter for the large circles 413 may be in a range of about 2.6 mm to about 2.3 mm. In one or more embodiments, the average diameter for the large circles 413 is about 2.4 mm.

In one or more embodiments, the diameter for the small circles 412 in FIG. 12 may be in a range of about 1.4 mm to about 2.5 mm. In another embodiment, the diameter for the small circles 412 may be in a range of about 1.6 mm to about 2.3 mm. In yet another embodiment, the average diameter for the small circles 412 may be in a range of about 1.8 mm to about 2.1 mm. In one or more embodiments, the average diameter for the small circles 412 is about 1.9 mm.

As described herein with reference to FIG. 12, in one or more embodiments, the ratio of perforated area to the whole cathode current collector (excluding the tabbing area 416, i.e. the tab area 416, in FIG. 12) may be in a range of about 0.40 to about 0.80 In another embodiment, the ratio of perforated area to the whole cathode current collector (excluding the tabbing area 416) may be in a range of about 0.50 to about 0.70 In yet another embodiment, the ratio of perforated area to the whole cathode current collector (excluding the tabbing area) may be in a range of about 0.55 to about 0.65 In one or more embodiments, the ratio of a perforated area to a whole area of cathode current collector (excluding the tabbing area) is about 0.60.

In one or more embodiments, the cathode current collector 400 has a thickness. In one or more embodiments, the thickness of the cathode current collector 400 may be in a range of about 0.002 mm to about 0.010 mm. In another embodiment, the thickness of the cathode current collector 400 may be in a range of about 0.040 mm to about 0.090 mm. In yet another embodiment, the thickness of the cathode current collector 400 may be in a range of about 0.060 mm to about 0.080 mm. In one or more embodiments, the thickness of the cathode current collector 400 is about 0.075 mm.

In one or more embodiments, the cathode current collector 400 is coated with conductive carbon. The coating can be done before pressing the pellet(s) 300. The pellets 300, 300 can be pressed together with the cathode current collector 400 disposed there-between. The conductive carbon coating may help to promote adhesion between the pellet (cathode formulation) and the cathode current collector, and to enhance the continuity of electrical conduction between the cathode current collector and the pellet.

In one or more embodiments, the conductive carbon material may include, but not be limited to, graphite with a thermoplastic binder. In one or more embodiments, the conductive carbon coating on the cathode current collector 400 may be obtained by application of a coating material such as commercially available Dag® EB-012 by Acheson Colloids Company on the cathode current collector surface. In one or more embodiments, the conductive carbon coating has a thickness. In one or more embodiments, the thickness of the conductive carbon coating may be in a range of about 0.040 millimeter (mm) to about 0.0120 mm. In another embodiment, the thickness of the conductive carbon coating may be in a range of about 0.050 millimeter (mm) to about 0.100 mm. In yet another embodiment, the thickness of the conductive carbon coating may be in a range of about 0.060 millimeter (mm) to about 0.090 mm. In one or more embodiments, the thickness of the conductive carbon coating is about 0.080 mm.

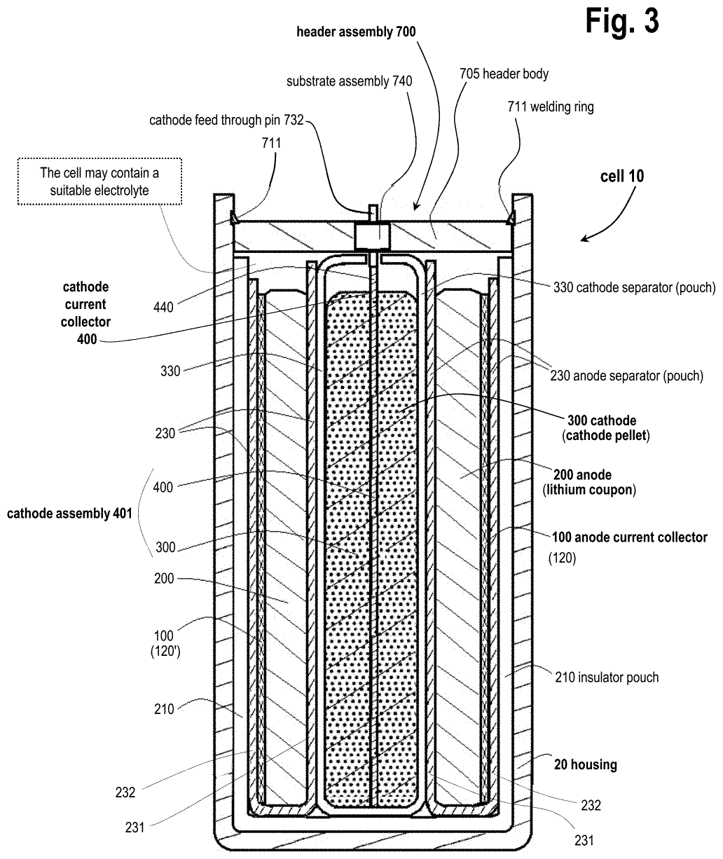

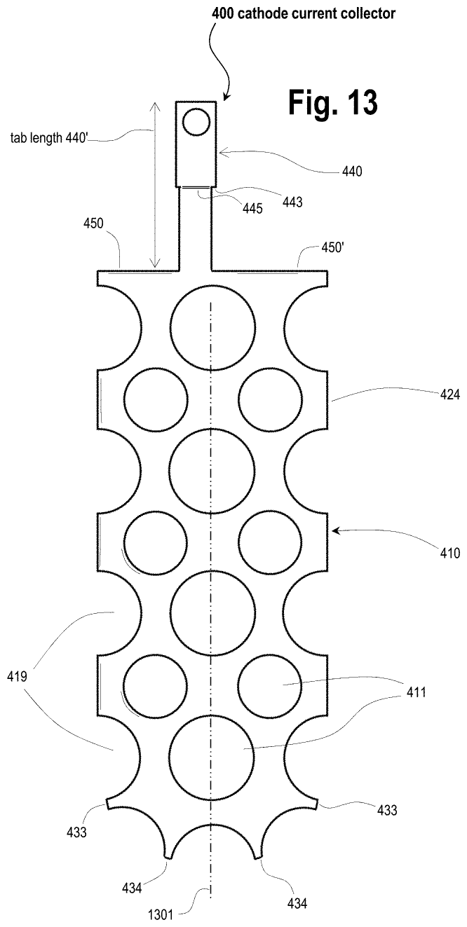

In various embodiments, advantages of using a perforated cathode current collector 400 can include improved pellet cohesion around the edges of the perforations. Further the alignment tab 440, as shown in FIG. 12 and in FIG. 13, can feature a partially etched cut line 445, which facilitates consistent pellet pressing while minimizing final tab length 440′ (see FIGS. 12 and 13) and interference of the tab 440 during assembly of the cell. Such assembly of the cell can include the placement, on the housing 20, of the header body with a header weld and/or other securement arrangement, i.e. such as the one or more welding rings 711 as shown in FIG. 3, for example. The partially etched cut line 445 can serve to demarcate the particular position of the cathode current collector 400 relative to the cathodes 300.

As described above, FIG. 12 is a perspective view a cathode current collector 400 of an electrochemical cell, in accordance with one or more embodiments.

FIG. 13 is a top view of a cathode current collector 400 of an electrochemical cell, the same as or similar to the cathode current collector of FIG. 12.

As described above, in accordance with one or more embodiments of the disclosure, the cell 10 can include a housing or casing 20. The cell 10 can also include a cathode current collector 400 that is disposed in the housing 20. The cathode current collector 400 can include a cathode tab 440 and a cathode plate or plate 410. The cathode tab 440 can include a tab or tabbing area 416. The tab area 416 can include a connection tab 441 and a shank 442. The connection tab 441 and the shank 442 can be separated by a partially etched cut line or etched cut line 445, as described above. The etched cut line 445 can be helpful in assembly of the cell. In particular, the etched cut line 445 can be helpful in assembly of the cathode pellets 300 on opposing sides of the cathode current collector 400. The tab 440 can be mounted to or integrally attached to an upper edge portion of the cathode plate 410. The shank 442 can be of smaller dimension than the connection tab 441 as provided by shoulders 443. The shoulders 443, as shown in FIG. 12 and FIG. 13, can be in line or collinear with the partially etched cut line 445. The tab 440 can include an aperture or hole 446. The hole 446 can be used to assist in connection of the tab 440 to a terminal and/or can assist in positioning of the cathode current collector 400, for example.

The cathode current collector 400 can also include a plate area 414. The cathode current collector 400 can also include a peripheral edge 415. The peripheral edge 415 can surround the plate area 414, excepting the tab area 416 at which the tab 440 connects onto or is integrally attached to the plate 410. Accordingly, the peripheral edge 415 can be characterized as surrounding at least a portion of the plate area 414. The peripheral edge 415 can include a plurality of partial perforations 419 or what might also be characterized as edge perforations 419. The partial perforations 419 can include side perforations 422, corner perforations 426, and a bottom perforation 432. As shown in FIG. 12, the cathode current collector 400 includes a plurality of side perforations 422 along opposing sides. Specifically, four side perforations 422 can be provided on each side of cathode plate 410. As also shown in FIG. 13, the lowermost side perforation 422 can be truncated or diminished at a lower portion of the plate 410, at respective corner edge 424, due to the rounding of the bottom portion 430 of the plate 410. The upper three side perforations 422, on each side of the plate 410, can be approximately half in the area of the perforations 413, described further below.

Each of the side perforations 422 can be defined by a side perforation edge 421. Each of the corner perforations 426 can be defined by a corner perforation edge 425. The bottom perforation 432 can be defined by a bottom perforation edge 431.

On both sides of the plate 410, the side perforation edge 421 can be separated from the corner perforation edge 425 by a corner edge segment 433. The corner edge segment 433 can also be characterized as a prong. On both sides of the plate 410, the corner perforation edge 425 can be separated from the bottom perforation edge 431 by a bottom edge segment 434. The bottom edge segment 434 can also be characterized as a prong.

Each of the side perforation edges 421 can be separated from another side perforation edge 421 by a side edge segment 424. Accordingly, each side of the plate 410 can include three side edge segments 424, i.e. for a total of six side edge segments 424, in accordance with one or more embodiments of the disclosure. The peripheral edge 415 can include the entire peripheral edge of the plate 410, excepting the tab connection, from one side of the tab 440 at a top edge 450 to the opposite side of the tab 440 at a top edge 450′. Accordingly, the peripheral edge 415 can include the top edges 450, 450′; two opposing upper corner edge segments 435; the side perforation edges 421; the side edge segments 424; the corner edge segments 433; the corner perforation edge 425; the bottom edge segment 434; the bottom perforation edge 431; and any other edges around the periphery of the plate 410 that may be associated with or provided between or amongst such identified edges. The top edge 450 can be of different length relative to the top edge 450′, i.e. the tab 440 need not be positioned at the center line 1301, as shown in FIG. 13 and can be offset from the center line 1301.

The structures or arrangements 422, 426, 432, can be characterized as partial perforations 419 in that such structures can be defined or include, on the peripheral edge 415, partial geometrical shapes such as a partial circle, for example. The various perforations can also be of irregular shape.

The plate area 414 can include a plurality of interior perforations 411 as described above. The interior perforations 411 can vary in size. The interior perforations 411 can include large perforations 413 and small perforations 412. However, such characterization is relative and different size perforations can be provided as desired.

As otherwise described herein, the cathode current collector 400 can be constructed of a variety of materials such as stainless steel, aluminum, and titanium. In general, the cell 10 can be constructed of material so as to be provided and configured to be implantable in a human.

In the arrangement as shown in FIG. 12 and FIG. 13, the large perforations 413 are aligned in the center and along a central line 1301 of the cathode plate 410. Also, the side perforations 422, of the portion that is provided, can be of similar shape and dimension to the large perforations 413. For example, the partial perforations 422 can be about the same diameter as the large perforations 413 in the interior or interior area of the plate area 414 of the plate 410. As shown in FIG. 12 and FIG. 13, the side perforations 422 may be horizontally aligned, on opposing sides, of each of the large perforations 413.

In accordance with at least some embodiments of the disclosure, an area of the interior perforations can be characterized as a perforated area or as a void area. Further, a ratio of the perforated area to the plate area 414, excluding the tab area 416, can be about 0.6, in accordance with one or more embodiments of the disclosure.

Accordingly, a proportion of perforation can be defined as the ratio of (a) surface area (or otherwise characterized as the lack of surface area) of any perforation void of material to (b) total surface area of the cathode current collector 400, excluding the tab area, in accordance with one or more embodiments.

In one or more embodiments, the cathode formulation can comprise a cathode active material, at least one conductive carbon filler, and a binder. In one or more embodiments, the cathode active material employed in the cathode formulation includes electrochemically active fluorinated carbon, i.e., CFₓ. In one or more embodiments, the CFₓ material may be blended with the binder and the conductive carbon to form the pellet 300. The pellet 300 may then be disposed onto the cathode current collector, i.e., the pellet 300 may be pressed onto the cathode current collector 400. In one or more embodiments, the conductive carbon filler may include carbon black.

In one or more embodiments, the cathode active material comprises fluorinated carbons represented by the formula CFₓ, wherein x is a number between 0.1 and 2.0. The atomic weight of fluorine is 18.998 and the atomic weight of carbon is 12.011. The fluorination level of a given CFₓ, material may be expressed as a percentage that represents the atomic weight contribution of the fluorine (18.998x) divided by the sum of the atomic weight contribution of the fluorine (18.998x) and the atomic weight contribution of the carbon (12.011). Thus, for C₁F₁ stoichiometry, the fluorination level would be 18.998/(18.998+12.011)=61.3 percent.

CFₓ can be conventionally prepared from the reaction of fluorine gas with a crystalline or amorphous carbon. Graphite is an example of a crystalline form of carbon, while petroleum coke, coal coke, carbon black and activated carbon are examples of amorphous carbon. The reaction between fluorine and carbon is usually carried out at temperatures ranging from 300 degrees Celsius to 650 degrees Celsius in a controlled pressure environment. A variety of CFₓ materials are available from commercial sources, including materials derived from the fluorination of petroleum coke, carbon black and graphite.

Suitable examples of fluorinated carbons that may be used in forming a cathode as disclosed herein include, but are not limited to, fluorinated carbons that are based on different carbonaceous starting materials. For example, a cathode in accordance with the disclosure can be formed by a fluorinated petroleum coke. The fluorinated petroleum coke for use in the present disclosure is preferably fully fluorinated to a fluorination level of approximately 58 to 65 percent, with x value between 0.9 to 1.2. However, other fluorination levels could potentially also be used. Advantages of using petroleum coke based CFₓ material is that it is thermally stable in contact with electrolyte in a wide temperature range of about −40 degrees Celsius to about 70 degrees Celsius. The petroleum coke based CFₓ material is also found to be chemically stable in contact with electrolyte, leading to minimal or no side reactions that may generate gas species causing cell swelling. Suitable examples of the CFₓ material include but are not limited to Carbofluor® 1000 from Advanced Research Chemicals (Catoosa Oklahoma).

In one or more embodiments, as mentioned herein, cathodes may include known non-electrochemically active materials, such as conductive fillers and a binder. In one or more embodiments, the conductive filler is carbon black, although graphite or mixtures of carbon black and graphite may also be used. In one or more embodiments, the conductive carbon filler used in the cathode formulation is also thermally and chemically stable. Suitable examples of the conductive carbon filler can include, but are not limited to, Super P®-Li from TIMCAL. Metals such as nickel, aluminum, titanium and stainless steel in powder form may likewise be used. Suitable examples of binder include but is not limited to an aqueous dispersion of a fluorinated resin material, such as a polytetrafluoroethylene (PTFE) or polyvinylidene fluoride (PVDF). In one or more embodiments, the binding material can be inert PTFE emulsion. It may be appreciated that those skilled in the art will, in light of the teachings of the present disclosure, appreciate that any suitable mixing ratio of the fluorinated carbon, the conductive filler, and the binder may be used. In an exemplary embodiment, the cathode may include, by weight, 90 percent of the fluorinated carbon material, 6.0 percent conductive filler and 4.0 percent binder.

During fabrication of the CFₓ cathode, the fluorinated carbon material, which comes in powder form, can be blended with the conductive filler. The CFₓ and conductive filler can then be combined with the binder by a wet process. The wetted cathode mixture can be intimately blended, filtered and dried, then pressed into a cathode current collector 400 as illustrated in FIG. 12. The current collector can assist in forming electrical conducting path between cathode and cell positive terminal and promote uniform utilization of the cathode material during discharge.

### Illustrative Examples

Example 1 provides construction details of cathode sample of an electrochemical cell in accordance with embodiments of the present disclosure.

In Example 1, during fabrication of the CFₓ cathode, the fluorinated carbon material, which comes in powder form, is blended with the conductive filler. The CFₓ and conductive filler are then combined with the binder by a wet process. The wetted cathode mixture is intimately blended, filtered and dried, then pressed into a cathode current collector 400 as illustrated in FIG. 2 and FIG. 3, for example. The current collector 400 will assist in forming an effective electrical conducting path between cathode assembly 401 and cell positive terminal and promote uniform utilization of the cathode material during discharge. The constructed cathode assembly 401 is illustrated in FIG. 2, in accordance with one or more embodiments of the disclosure.

Example 2 provides construction details of electrochemical cells in accordance with one or more embodiments of the present disclosure.

In Example 2, four electrochemical cells were constructed. Each of the electrochemical cells has a cathode with an active material of fluorinated carbon on a perforated metal cathode current collector 400, a lithium anode on a perforated metal anode current collector 100, an electrolyte, and a separator, all enclosed in a titanium housing 20, as illustrated in FIG. 1. The cathode current collector 400 in Example 2 is a perforated stainless steel (FIG. 12) and is not coated with carbon conductive layer on its surface.

Example 3 provides construction details of electrochemical cells in accordance with embodiments of the present disclosure.

In Example 3, five electrochemical cells were constructed. Each of the electrochemical cells has a cathode with an active material of fluorinated carbon on a perforated metal cathode current collector 400, a lithium anode on a perforated metal anode current collector 100, an electrolyte, and a separator, all enclosed in a titanium housing 20, as illustrated in FIG. 1. The cathode current collector 400 in this Example 3 can be a perforated stainless steel (FIG. 12) and can be coated with carbon conductive layer on its surface.

Example 4 provides details of electrical testing of electrochemical cells from Example 2 and Example 3.

In Example 4, using a battery testing equipment, a current pulse was applied to each of the cells from Example 2 and Example 3. The amplitude of the current pulse is 5.0 milli-Amperes. The duration of the current pulse is 15 seconds. The pulse applied to each cell at time 0 after the cells were constructed. Each of the cells was aged at 37 degree Celsius for 1 week, 2 weeks, 3 weeks, 4 weeks, and 5 weeks. In the meantime, each of the cells was pulsed after these aging periods.

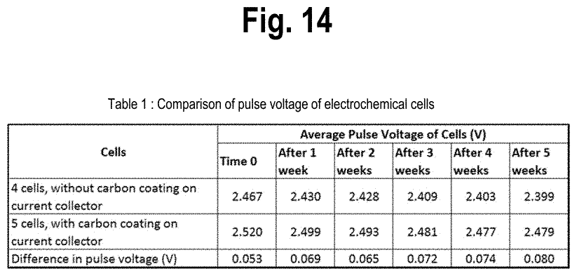

Table 1, as shown in FIG. 14, provides the pulse voltage of the cells, in accordance with one or more embodiments and aspects of the disclosure. The pulse voltage value is an average of multiple cells. It is shown in Table 1 that the cells having carbon conductive coating on the cathode current collector showed (0.053 to 0.080 volt) higher pulse voltage than the cells having no carbon conductive coating on the cathode current collector. This demonstrates that the carbon conductive coating on the cathode current collector improved the electrical conducting path between the cathode pellet and the cathode current collector, and increased the discharge efficiency, enabling the cell to deliver higher energy density.

Accordingly, an electrochemical cell is provided, which converts chemical energy to electrical energy, that includes a cathode with an active material of fluorinated carbon on a perforated metal cathode current collector, a lithium anode on a perforated metal anode current collector, a stable electrolyte, and a separator. In various embodiments, a cathode current collector arrangement, a cathode formulation, and a battery incorporating the electrochemical cell are provided.

Particularly, in various embodiments, a cathode current collector arrangement in the electrochemical cell is provided. The cathode current collector arrangement can include perforations.

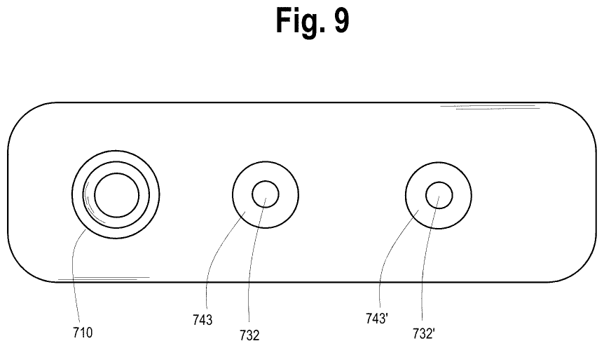

Hereinafter, further details of the cell 10 and various components thereof, as shown in FIGS. 1 through 11, will be described in accordance with one or more embodiments of the disclosure. In particular, further aspects of the anode current collector will be described.

As described above, FIG. 1 is a diagram showing an electrochemical cell 10, in accordance with one or more embodiments. The housing 20 in conjunction with the header assembly 700 contains various components as described above. In particular, the cell 10 also includes an anode current collector 100.

FIG. 2 shows an exploded view of an electrochemical cell 10 the same as or similar to the cell 10 of FIG. 1, in accordance with one or more embodiments.

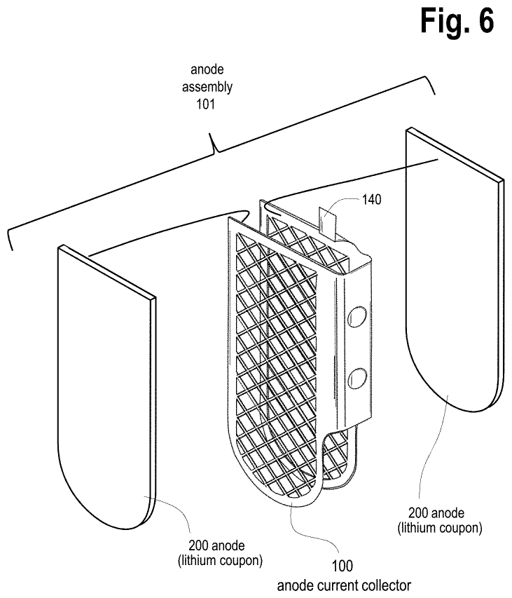

As shown in FIG. 2, the cell 10 includes at least one anode 200 (as shown two anodes 200) and an anode current collector 100. The anode 200 may comprise one, two or more metallic lithium coupons 200, pressed onto the current collector 100. The (a) anodes 200, which may be constituted by lithium coupons, and (b) anode current collector 100 can collectively be characterized as an anode/anode current collector assembly 101 or lithium coupon/anode current collector assembly 101, or simply characterized as an anode assembly 101 as shown in FIG. 6, for example, and further described below.

Relatedly, the cathode current collector 400 and the one or more cathode/cathode pellets 300 can be characterized as a cathode assembly 401, as shown in FIG. 3.

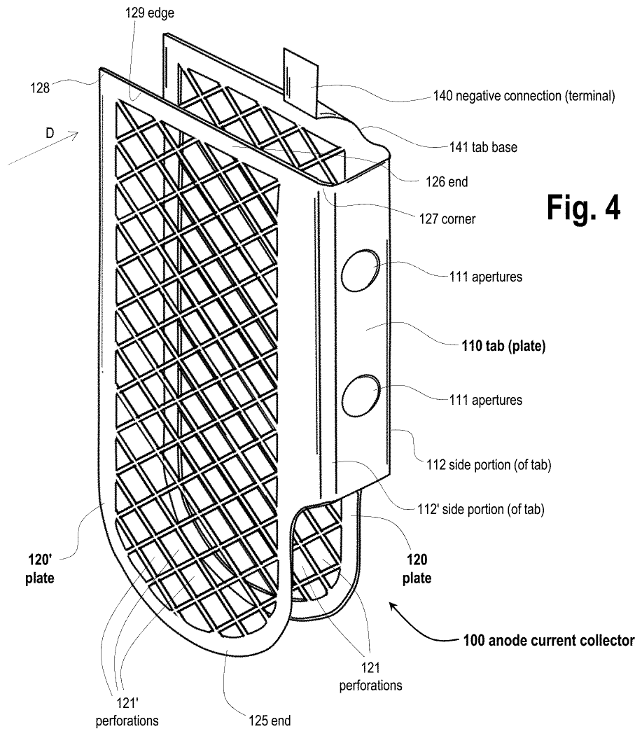

The anode current collector 100 may be constructed of material such as stainless steel or copper, for example. The current collector 100, as also shown in FIG. 4, is perforated 121 in accordance with one or more embodiments. The perforations 121 may be diamond shape, circular shape, rectangular shape, square shape and/or other shapes. The ratio of perforated area to the total area of the collector (excluding the central folding and tabbing area) may be about 0.6, for example, in accordance with one or more embodiments, and as otherwise described herein. The thickness of the current collector 100 may be about 0.050 mm. An alignment feature 110, 111 may be provided in the center of the current collector 100 that facilitates proper anode to current collector alignment and proper anode current collector folding, which may be key steps in cell construction. The electrochemical cell of FIG. 2 includes two lithium coupons, i.e. anodes, 200 and one folded anode current collector 100. The perforations 121 in a particular anode current collector 100 may be of different shape, such as some perforations having a diamond shape and some perforations having a rectangular shape, for example.

Such electrodes, i.e. the lithium coupons 200, may be advantageously used as the anode of a primary lithium electrochemical cell, for example of various cathode types such as the Li/CFₓ type with x comprised between 0.6 and 1.2, the Li/MnO₂ type, or the Li/SVO type (where SVO is silver vanadium oxide), in order to reduce the quantity of undischarged residual lithium and to increase consistency in discharge capacity.

An aspect of the disclosure is also a primary electrochemical cell with a non-aqueous electrolyte comprising one or more anodes, as described herein. The primary electrochemical cell may be provided with a non-aqueous electrolyte including Li/CFₓ (where x is comprised between 0.6 and 1.2), Li/MnO₂, Li/SVO, or Li/hybrid, where the hybrid is a mixture of CFₓ, and/or MnO₂, and/or SVO, for example.

FIG. 2 and FIG. 3 show further detail of the interrelationship of the various components of the cell 10. As described above, the cell 10 includes the housing 20 and the header assembly 700. The housing 20 in conjunction with the header assembly 700 contains various components of the cell including electrolyte of the cell.

An insulator pouch 210 may be provided inside the housing 20 so as to provide a lining to the housing 20. As shown in FIG. 3, for example, inside the insulator pouch 210 is provided an anode separator 230. The anode separator 230 may be in the form of a folded pouch, as also shown in FIG. 2, so as to form two sides 236, 237. Accordingly, the anode separator pouch 230 may be in a folded arrangement as shown in FIG. 2. The anode separator pouch 230 may include an inner lining 231 and an outer lining 232. Inside each side of the anode separator pouch 230 may be positioned both anode 200 and plates 120, 120′ of anode current collector 100, in accordance with one or more embodiments. The anode 200 may be in the form of a lithium coupon 200. The lithium coupons 200 can be respectively positioned on the anode current collector plates 120, 120′, so as to form the anode assembly 101. As shown in FIG. 3, the lithium coupons 200 are positioned on an interior side of the respective collector plate 120, 120′ to which each is attached. The lithium coupon/anode current collector assembly 101, i.e. the anode assembly 101, is enclosed in the anode separator pouch 230 with open or closed top. With regard to the anode separator pouch 230, the inner lining 231 height can be greater than the outer lining 232 height, to provide good isolation between a cathode assembly 401 and anode assembly 101. In accordance with one or more embodiments of the disclosure, the anode current collector 100 and anodes 200 can be slid into the anode separator pouch 230 from above the anode separator pouch 230, i.e. slid into the top of the anode separator pouch 230. In particular, (1) one side of the anode assembly 101 (plate 120, anode 200) can be slid into one side of the anode separator pouch 230 between the outer lining 232 and the inner lining 231, in conjunction with (2) the other side of the anode assembly 101 (plate 120′, anode 200) can be slid into the other side of the anode separator pouch 230 between the outer lining 232 and the inner lining 231. As a result, the arrangement illustrated in FIG. 3 can be provided.

As shown in FIG. 2 and FIG. 3, the housing 20 also includes a cathode separator 330, which may be in the form of a cathode separator pouch 330. The cathode separator pouch 330 may be provided between the two sides 236, 237 of the anode separator pouch 230, as such is folded. Provided within the cathode separator pouch 330 is one or more cathodes 300 and a cathode current collector 400. Each cathode 300 may be constituted by a cathode pellet 300. Dimensions of the cathode 300 are shown in FIG. 2 and FIG. 3.

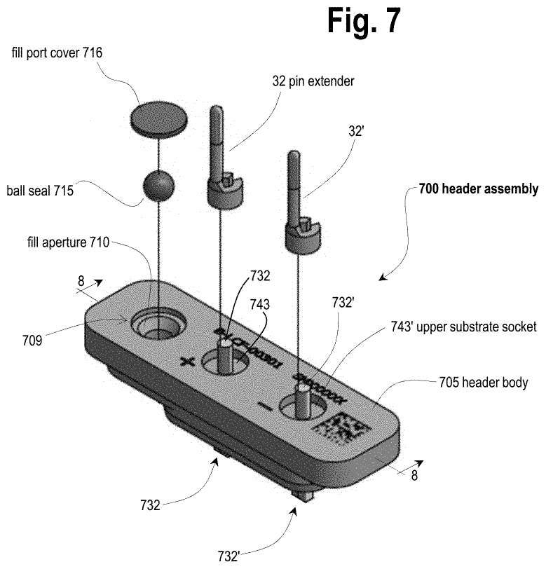

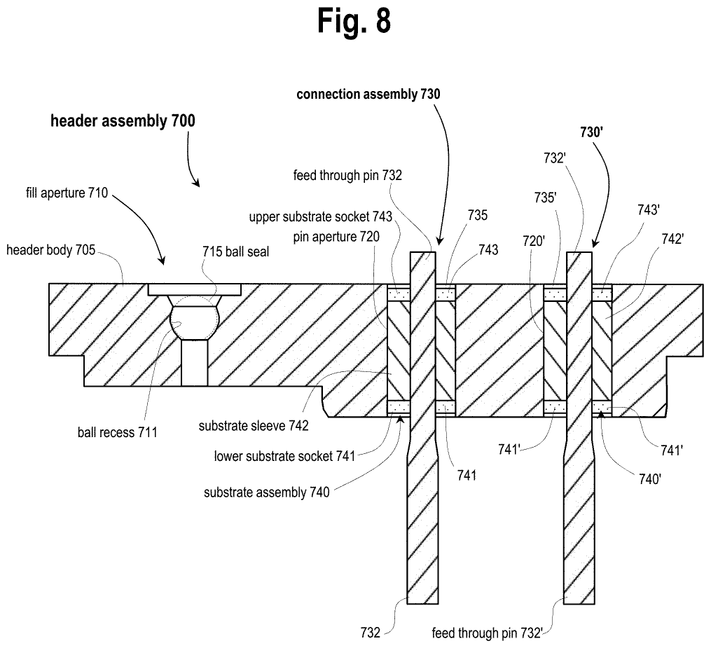

As described above, the cathode current collector 400 may be provided in the form of or include a plate that is provided between the two cathodes 300. The cathode current collector 400, i.e. plate for example, may be constituted and/or include a body that extends throughout a substantial or desired extent of the width and height of the cathode(s) 300. A cathode connection 440 or cathode positive connection 440, i.e. a tab 440, may be integrally formed with and/or can be a part of the cathode current collector 400 and extend above the cathodes 300 as is shown in both FIG. 2 and FIG. 3. The cathode positive connection 440 may engage with a corresponding connection in header body 705. For example, the cathode positive connection 440 may engage with, as shown in FIG. 3, cathode feedthrough pin 732. Relatedly, the negative connection or tab 140 of the anode assembly 101 may engage with a corresponding connection in header body 705. Further details are described below with reference to FIGS. 7 and 8, for example.

In accordance with at least some embodiments of the disclosure, a header assembly 700 is shown in FIG. 2 and FIG. 3 and is shown in further detail in FIG. 7. The header assembly 700 includes a header body 705. The header body 705 may be shaped so as to conform and mate with an inner periphery of the housing 20. For example, one or more welding rings 711 (FIG. 3) or other connection structure may be utilized to attach the header assembly 700 to the housing 20 at a desired position.

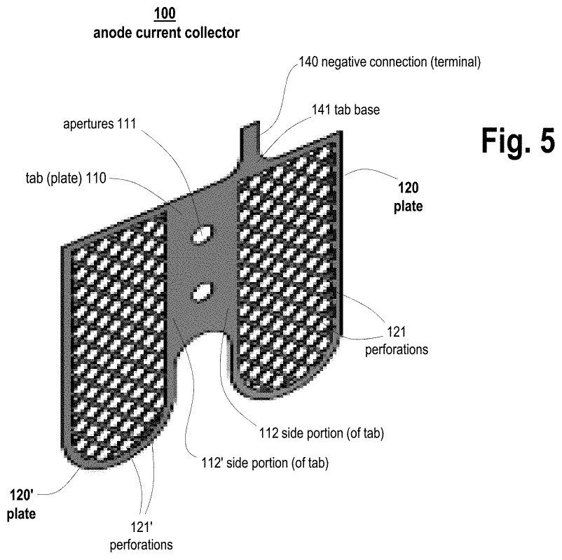

FIG. 4 shows anode current collector 100 in a folded state. According to one or more embodiments, as described above, two metallic lithium coupons 200 are used as the anode of the electrochemical cell, as shown in FIGS. 2, 3 and 6, for example. The lithium coupons 200 may be respectively fixed or positioned adjacent to the anode current collector 100. FIG. 5 represents a flat view of a metallic current collector 100, in accordance with one or more embodiments. That is, FIG. 5 shows an anode current collector 100 in a flattened or unfolded state. As shown in FIG. 4 and FIG. 5, the anode current collector 100 includes a first plate 120, a second plate 120′, and a tab or bridge plate 110 that serves to connect the plates 120, 120′. The current collector 100 can include perforations. More specifically, the plates 120, 120′ may be provided with perforations 121, 121′. The plates 120, 120′ may be flat or substantially flat as shown in FIG. 4, i.e. in an operational configuration as shown in FIG. 4. Alternatively, the plates 120, 120′ may be some other shape (and not flat), such as curved in a direction along tab 110 and/or curved in a direction perpendicular to a length of the tab 110, for example.

From the perspective along direction D in FIG. 4, the plate 120 may be the same shape as the plate 120′. For example, the plate 120 may include a first end 125 and a second end 126, with the first end being rounded and the second end defined by two corners 127, 128 and linear edge 129 extending between such two corners 127, 128. In general, as otherwise described herein, the plate 120 may be mirror image of, and have the same structure as, the plate 120′.

As shown in FIG. 5 and FIG. 4, the current collector 100 also may be provided with alignment features including solid tab or plate 110 in the center of the anode current collector 100. The solid tab or plate 110 may be characterized as a bridge plate in that tab 110 bridges between the plate 120′ and the plate 120. The tab 110 may be provided with a plurality of apertures 111. The lithium coupons 200 can be positioned on the anode current collector plates 120, 120′ (for example, on an interior side of the anode current collector plates 120, 120′), and the anode current collector 100 can be folded to the shape of design. The one or more apertures 111 can serve as an alignment feature during anode assembling process or assembling process of the cell 10. The apertures 111 can help the anode current collector 100 be positioned on a fixture or assembly, and can assist to allow consistent and accurate placement of one or more lithium coupons 200 at or on the correct position on the anode current collector 100, i.e. on the plates 120, 120′. In addition, the apertures 111 can help fold the current collector correctly. As shown in FIG. 5, the tab 110 can include a side portion 112. The plate 120 is attached along the side portion 112. The tab 110 can also include a side portion 112′. The plate 120′ is attached along the side portion 112′.

Accordingly, the tab 110 can have a plurality of apertures 111 that include a first aperture and a second aperture, and the first aperture positioned over the second aperture in the tab. The first aperture and the second aperture can each be centered in the tab 110 between a first side portion 112 and the second side portion 112′, as shown in FIG. 4, for example.

As shown in FIG. 5, the anode current collector 100 may also be provided with a negative connection, terminal or tab 140, in accordance with one or more embodiments of the disclosure. The negative connection 140 may be a terminal, tab, or similar structure that extends from one of the plates 120, 120′ or may extend from the tab 110. The connection 140 may include a tab base 141 that is widened and/or may be of structure or shape as desired.

The proportion of perforation can be defined as the ratio of (a) surface area (or otherwise characterized as the lack of surface area) of the perforation void of material to (b) total surface area of the collector excluding the central folding and tab area, in accordance with one or more embodiments. With reference to FIG. 4, which shows the anode current collector 100 in a folded state, a tab area may be characterized as the area of the anode current collector 100 that is provided substantially in the same plane as the apertures 111, i.e. substantially co-planer to the apertures 111, and the turned corners or edges along each side portion 112, 112′ of the tab 110. In accordance with one or more embodiments, the proportion of perforation of a current collector may be between 30% and 90%, preferably may be between 40% and 80%, or preferably may be between 50% and 70%, for example. The current collector 100 may allow uniform utilization of lithium coupons during discharge. At the same time, the perforated anode current collector 100 can occupy a minimal amount of volume inside the cell 10, allowing maximization of the amount of electrochemically active components in the cell 10 and—as a result—provide high energy density.

In accordance with one or more embodiments, the total surface area of the current collector 100 excluding the central folding and tab area may be equal to or be a little smaller than the area of the lithium coupons. In accordance with one or more embodiments, the ratio of the surface area of the current collector 100 (excluding the central folding and tab area) to the area of the lithium coupons may be between 70% to 100%, preferably may be between 80% and 100%, or preferably may be between 90% and 100%. Such ratio of the surface area of the current collector (excluding the central folding and tab area) to the area of a lithium coupon may relate to one side (i.e. plate) 120, 120′ of the anode current collector 100 vis-à-vis a corresponding lithium coupon (i.e. anode) 200 pressed onto or associated with such respective plate 120, 120′, for example. Relatedly, it is appreciated that the provided structure including the two sides of the anode current collector 100 and associated anode 200 may be mirror image of each other, i.e. such that ratios of such mirror image structure would be the same.

The current collector 100 may be a perforated metal, a stamped metal, an expanded metal, a grid, or a metallic fabric, for example. Thickness of the current collector 100 preferably may be between 0.010 mm and 0.100 mm, preferably may be between 0.020 mm and 0.070 mm, and preferably may also be between 0.04 and 0.06 mm. The material serving as a current collector is preferably chosen from the group comprising copper, stainless steel, nickel and/or titanium, for example. In accordance with one or more embodiments, preferably, the material may be pure copper—as pure copper has a high electric conductivity.

The alignment feature in the center of the current collector assists proper anode to current collector alignment and anode current collector folding, which may be key aspects of cell construction, in accordance with one or more embodiments.

As illustratively shown in FIG. 4 and described above, for example, two holes, openings, or apertures 111 in the center of the tab 110 allow the current collector to sit, be supported and/or be seated on a fixture in a stationary disposition. In such disposition, the lithium coupons or anodes 200 can be pressed properly onto the current collector 100. Also, the two or more holes 111 afford a void of material that may allow easier folding of the current collector. Such arrangement may provide for (a) proper and/or needed geometry of the anode current collector 100 and other components within the cell, and (b) proper sandwiching of the cathode assembly 401 to fit into the cell case or housing 20. The lithium coupons 200 can be positioned on the anode current collector plates 120, 120′, and the anode current collector 100 can be folded to the shape of design, such as shown in FIG. 4. The aperture(s) 111 may serve as alignment feature during an assembling process. The apertures can help the anode current collector 100 be positioned on a support structure, and assists to allow consistent placement of a lithium coupon(s) 200 at the correct position on the anode current collector 100. In addition, the aperture(s) 111 can help fold the current collector 100 correctly.

In accordance with one or more embodiments of the disclosure, the apertures 111 can be fitted on or into a jig or assembly structure in the assembly process, so as to support the anode current collector 100. For example, the apertures 111 can be fitted over a pair of protuberances or studs (in or on an assembly structure) that match with the apertures 111. As a result, the anode current collector 100 can be accurately positioned on the assembly structure. The anodes 200, e.g. lithium coupons, can also be supported or positioned on the support structure on a respective, defined support that accurately positions the anodes 200 on the support structure. As a result of the accurate positioning of the lithium coupons 200 and the accurate positioning of the anode current collector 100 on the support structure, in the assembly process, each anode 200 can be accurately positioned on a respective plate of the plates 120, 120′.

Such a support structure can be positioned in the interior of the anode current collector 100 so as to support the anode current collector 100 and so as to be positioned to support the anodes 200. Such a support structure can also include bend plates that approach or sweep up on opposing sides of the supported anode current collector 100, so as to bend each plate 120, 120′ from a disposition shown in FIG. 5 to a disposition as shown in FIG. 4. Such an assembly process may also include heat applied, such as to the anode current collector 100.

As described above, the anode current collector 100 may include a negative current output terminal or connection 140 of the cell, which can be connected either to the current collector tabbing, or to the metallic lithium strip, or to both, for example.

In accordance with one or more embodiments, an electrode according to the disclosure can be used as an anode (negative electrode) of a primary lithium battery with a non-aqueous electrolyte. The electrolyte can be a salt (such as LiBF₄) dissolved in organic solvent or in a mixture of solvents.

The primary electrochemical cell can be the types of Li/CFₓ (where x is comprised between 0.6 and 1.2), Li/MnO₂, Li/SVO, or Li/hybrid, where hybrid is a mixture of CFₓ, and/or MnO₂, and/or SVO.

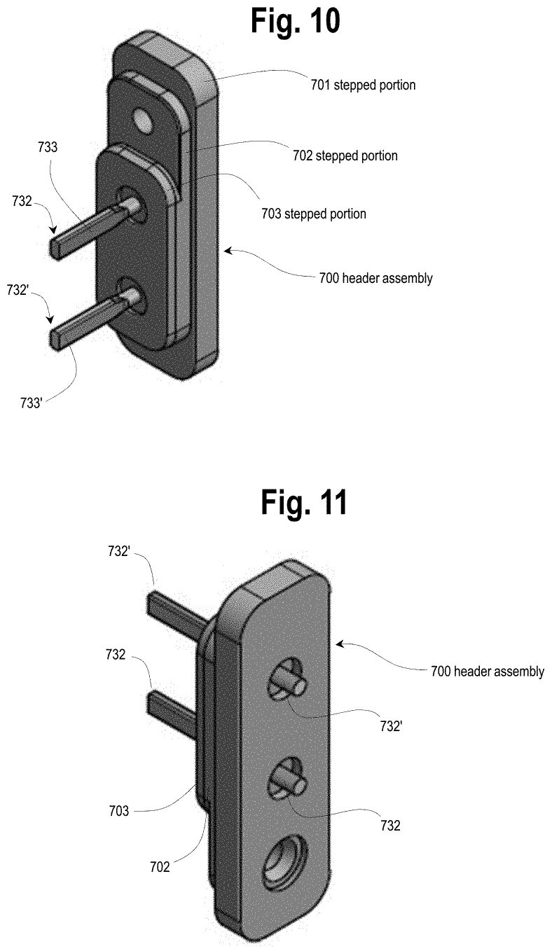

FIG. 7 is a perspective view of a header assembly of a battery, showing Detail A of FIG. 2, in accordance with one or more embodiments. FIG. 8 is a cross-section view, along line 8-8 of FIG. 7, of a header assembly the same as or similar to the header assembly of FIG. 1, in accordance with one or more embodiments. As shown in FIG. 7, the header assembly includes a header body 705. The header body 705 may be dimensioned so as to be received into housing 20. The header body may be stepped 701, 702, 703 (FIG. 10) so as to accommodate components supported by the header body 705 as well as components positioned adjacent to the header body 705.

The header body 705, as shown in FIGS. 7 and 8, includes a fill aperture 710 at the vent location 709. The fill aperture 710 may be provided to add or remove electrolyte from the cell 10. The fill aperture 710 may be provided with a valve to prevent fluid flow there through. In accordance with one or more embodiments, the valve may be a ball valve, with the fill aperture dimensioned about a centerline so as to receive a ball seal 715. A fill port cover 716 may be provided to cover the fill aperture 710 and valve of the aperture.

As shown in FIG. 8, the header body 705 may also be provided with at least one pin aperture 720. The pin aperture 720 is provided to accommodate a connection assembly 730. The connection assembly 730 provides an electrical path from an interior of the housing, in which the cell is located, through the connection assembly 730, to an exterior of the housing. In accordance with one or more embodiments, the connection assembly 730 includes a feed through pin 732. The feed through pin 732 provides a conductive path through the header body 705. The feed through pin 732 may be supported by a substrate assembly 740. The substrate assembly 740 can include a lower substrate socket 741, a substrate sleeve 742, and an upper substrate socket 743. The substrate assembly 740 can provide a seal around and/or provide support to the feed through pin 732 in the pin aperture 720. The lower substrate socket 741 and the upper substrate socket 743 can be annular in shape, i.e. donut shaped, so as to encircle the feed through pin 732. The lower substrate socket 741 and the upper substrate socket 743 may be glass, resin or other suitable material. The lower substrate socket 741, upper substrate socket 743, and substrate sleeve 742 can be constructed of insulating material.

The feed through pin 732 may be connected to respective mating electrical connections. The feed through pin 732 may be connected to a pin extender 32 as shown in FIG. 7. The pin extender 32 may mate with the feed through pin 732 in telescopic manner as shown, or in other suitable manner. Relatedly, the header body 705 may be provided with an annular recess 735 so as to receive at least a portion of the pin extender 32—so as to provide a more secure, stable and supported connection engagement. The annular recess 735 can be provided or defined by the pin aperture 720 and a top surface of the upper substrate socket 743.

The feed through pin 732 may be connected to the cathode positive connection or tab 440 so as to provide electrical connection between the cathode current collector 400 and the pin extender 32. The feed through pin 732 may be dimensioned or flattened 733 on one or more sides as shown in FIG. 10 and FIG. 11 so as to effectively engage with the tab 440 or other connection and accordingly provide electrical connection between the cathode current collector 400 and the pin extender 32.

The header assembly 700 may also be provided with connection assembly 730′. The connection assembly 730′ provides an electrical path from an interior of the housing, in which the cell is located, through the connection assembly 730′, to an exterior of the housing. In accordance with one or more embodiments, the connection assembly 730′ can include a feed through pin 732′. The feed through pin 732′ may be supported by a substrate assembly 740′. The substrate assembly 740′ can include a lower substrate socket 741′, a substrate sleeve 742′, and an upper substrate socket 743′. The substrate assembly 740′ can provide a seal around and/or provide support to the feed through pin 732′ in a pin aperture 720′. The lower substrate socket 741′ and the upper substrate socket 743′ can be annular in shape, i.e. donut shaped, so as to encircle the feed through pin 732′. The lower substrate socket 741′ and the upper substrate socket 743′ may be glass, resin or other suitable material. The lower substrate socket 741′, upper substrate socket 743′, and substrate sleeve 742′ can be constructed of insulating material.

The feed through pin 732′ may be connected to respective mating electrical connections. The feed through pin 732′ may be connected to a pin extender 32′ as shown in FIG. 7. In particular, the pin extender 32′ may mate with an upper end of the feed through pin 732′ in manner as shown, or in other suitable manner. Relatedly, the header body 705 may be provided with an annular recess 735′ so as to receive at least a portion of the pin extender 32′—so as to provide a more secure and supported connection engagement. The annular recess 735′ can be provided or defined by the pin aperture 720′ and a top surface of the upper substrate socket 743′.

The feed through pin 732′ may be connected to the anode negative connection or tab 140 so as to provide electrical connection between the anode current collector 100 and the pin extender 32′, in accordance with one or more embodiments of the disclosure. The feed through pin 732′ may be dimensioned or flattened 733′ on one or more sides as shown in FIG. 10 and FIG. 11 so as to effectively engage with the tab 140 or with another connection assembly, and accordingly provide electrical connection between the anode current collector 100, with tab 140, and the pin extender 32′.

Both the pin extender 32 and the pin extender 32′, as shown in FIG. 7 may be plated and/or otherwise enhanced so as to provide good electrical connection to yet further electrical respective connections, i.e. that are placed or positioned, respectively, onto the pin extender 32 and the pin extender 32′.

The connection assembly 730 and the connection assembly 730′ may be of the same or similar construct. The connection assembly 730 and the connection assembly 730′ may provide respective pass-through connections so as to provide electrical connection between the interior and the exterior of the cell.

As shown in FIGS. 10 and 11, for example, the header assembly 700 may include first stepped portion 701, second stepped portion 702, and third stepped portion 703. The stepped portions 701, 702, 703 may be shaped and dimensioned so as to provide for the fill aperture 710, to provide desired stability and support to the feed through pins 732, 732′, and so as to accommodate or support other components as described herein.

In accordance with one illustrative example, one anode can be prepared from two metallic lithium coupons with a perforated current collector made of copper. The copper current collector can be perforated with diamond shape perforations. The ratio of perforated void area to the total area of current collector (excluding the central folding and tabbing area) can be 0.6. The thickness of the current collector 100 can be 0.050 mm. The cell negative terminal can be connected to a negative connection or tab 140 of the current collector.

It is appreciated that the various components of embodiments of the disclosure may be made from any of a variety of materials including, for example, metal, copper, stainless steel, nickel, titanium, plastic, plastic resin, nylon, composite material, glass, and/or ceramic, for example, or any other material as may be desired.

A variety of production techniques may be used to make the apparatuses as described herein. For example, suitable casting and/or injection molding and other molding techniques, welding, bending techniques, and other manufacturing techniques might be utilized. Also, the various components of the apparatuses may be integrally formed, as may be desired, in particular when using casting or molding construction techniques.

The various apparatuses and components of the apparatuses, as described herein, may be provided in various sizes, shapes, and/or dimensions, as desired.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that when an element or layer is referred to as being “onto” another element or layer, the element or layer can be directly on another element or layer or intervening elements or layers. Examples include “attached onto”, secured onto”, and “provided onto”. In contrast, when an element is referred to as being “directly onto” another element or layer, there are no intervening elements or layers present. As used herein, “onto” and “on to” have been used interchangeably.

It will be understood that when an element or layer is referred to as being “attached to” another element or layer, the element or layer can be directly attached to the another element or layer or intervening elements or layers. In contrast, when an element is referred to as being “attached directly to” another element or layer, there are no intervening elements or layers present. It will be understood that such relationship also is to be understood with regard to: “secured to” versus “secured directly to”; “provided to” versus “provided directly to”; “connected to” versus “connected directly to” and similar language.

As used herein, the term “and/or” includes any and all combinations of one or more of the associated listed items. The singular forms “a”, “an” and “the” can include plural referents unless the context clearly dictates otherwise.

The term “optional” or “optionally” means that the subsequently described event, feature or circumstance may or may not occur, and that the description includes instances where the event, feature or circumstance occurs and instances where the event, feature or circumstance does not.

It will be understood that, although the terms first, second, third, etc., may be used herein to describe various features, elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper”, “top”, “bottom”, “left”, “right” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment.

Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure.

All related art references and art references discussed herein are hereby incorporated by reference in their entirety. All documents referenced herein are hereby incorporated by reference in their entirety.

In conclusion, it will be understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A cell comprising:
a housing;
a cathode current collector, in the housing, including a cathode tab and a cathode plate, and the cathode tab including a tab area, and the cathode plate including a plate area and a peripheral edge that surrounds at least a portion of the plate area, and
the peripheral edge including a plurality of partial perforations; and
the plate area including a plurality of interior perforations;
an anode current collector, in the housing, including an anode tab;
an anode, in the housing, provided adjacent the anode current collector; and
a cathode, in the housing, provided adjacent to the cathode current collector.

2. The cell according to claim 1, wherein the cell is constructed of material so as to be configured to be an implantable in a human.

3. The cell according to claim 1, wherein the cathode current collector is constructed of at least one selected from the group consisting of stainless steel, aluminum and titanium.

4. The cell according to claim 1, wherein the plate area including a plurality of interior perforations, the plurality of interior perforations including large perforations and small perforations, and the small perforations being smaller than the large perforations.

5. The cell according to claim 4, wherein the large perforations are in the form of circles and the small perforations are in the form of circles.

6. The cell according to claim 5, wherein the large perforations are about 2.4 mm in diameter and the small perforations are about 1.9 mm in diameter.

7. The cell according to claim 5, wherein the large perforations are provided in a line along a center line of the cathode plate.

8. The cell according to claim 4, wherein an area of the interior perforations constitutes a perforated area, and a ratio of the perforated area to the plate area is about 0.6.

9. The cell according to claim 4, wherein the partial perforations are provided on opposing sides and on a bottom portion of the cathode plate.

10. The cell according to claim 9, wherein at least some of the plurality of partial perforations is of a diameter that is about the same diameter as the large perforations in the plate area.

11. The cell according to claim 9, wherein at least some of the partial perforations are arranged in pairs, with each partial perforation of the pair on opposing sides of the cathode plate.

12. The cell according to claim 11, wherein the partial perforations, on opposing sides of the cathode plate and arranged in pairs, are aligned with a respective large perforation.

13. The cell according to claim 1, wherein an area of the interior perforations constitutes a perforated area, and a ratio of the perforated area to the plate area is about 0.6.

14. The cell according to claim 1, wherein the peripheral edge surrounds the plate area, except the tab area.

15. The cell according to claim 1, wherein the partial perforations include two opposing corner perforations that are defined by a respective corner perforation edge, and each corner perforation edge being a part of the peripheral edge.

16. The cell according to claim 1, wherein the partial perforations include a bottom perforation that is defined by a bottom perforation edge, and the bottom perforation edge being a part of the peripheral edge.

17. The cell according to claim 1, wherein a thickness of the cathode current collector is about 0.075 mm.

18. The cell according to claim 1, wherein the cathode includes two cathodes that are each in the form of a pellet on opposing sides of the cathode current collector, and the peripheral edge, including the plurality of partial perforations, improves cohesion of the pellets to the cathode plate around the peripheral edge.

19. The cell according to claim 18, wherein the cathode tab constitutes an alignment tab that serves to assist in alignment of the pellets to the cathode current collector, and the cathode tab including:
a partially etched cut line that facilitates consistent pellet pressing, of the pellets upon the cathode current collector, in assembly of the cell.

20. The cell according to claim 1, further including a header assembly that is attached to the housing and that includes pass through connections, and
the cathode tab and the anode tab respectively connected to respective pass through connections, of the header assembly, so as to provide electrical connection exterior of the cell so as to electrically connect to the cell to a power consuming device.
